(19) United States
(12) Patent Application Publication
(10) Pub. No.: US 2008/0163820 A1
(43) Pub. Date: Jul. 10, 2008

(54) Pest-resistant pet food container

(76) Inventor: Curtis Bennett, Interlachen, FL (US)

Correspondence Address: BEN SANDERS, 9857 NW 136TH DR, ALACHUA, FL, 32615, US

(21) Appl. No.: 11/650,161

(22) Filed: Jan. 5, 2007

(51) Int. Cl. A01K 5/00

(52) U.S. Cl. 119/61.54

(57) ABSTRACT

The invention described herein is a pest-deterrent pet food bowl for the feeding and watering of pets which contains a pet food bowl, wherein a detachable center chamber holds the food or drink, and a base chamber surrounds the center chamber to form a moat. The moat is filled with a pest-deterrent substance, thereby providing a barrier to unwanted pests. The base chamber has guides emerging from its bottom, which prevent or restrict movement of the detachable center chamber when it is placed in the base chamber. The center chamber has a step emerging from its outer edge, allowing a small pet to cross the large moat and be able to reach the food in the center chamber.

### FIELD OF INVENTION

The field of the present invention is that of bowls or containers for the feeding of dogs, cats, and other pets. Specifically, the present invention is directed towards bowls or containers which deter the intrusion of unwanted pests into the food or drink provided for pets. The basic problem solved is that of providing selective access, and allowing pets ready access to their food while denying access to unwanted pests.

### BACKGROUND OF THE INVENTION

Pet food bowls left outside the protection of a home are prone to infestation by insects and other pests, usually ants. Many inventors have attempted to solve this problem by utilizing a variety of methods to protect pet food bowls. One common method is to use a chemical insecticide as a barrier to protect the pet food bowl. For example, U.S. Pat. No. 6,513,281 discloses a coaster stand for pet food bowls which contains insect repellent. However, devices using insecticides are problematic, since they can be toxic and harmful to both humans and pets, and since they can pose some risk even if the bowl barrier is implemented in a manner which minimizes contact with the pet. In addition, replacing the insecticide may present extra cost to the user and may pose difficulties in reapplication.

Some outdoor pet food bowls utilize a liquid-filled moat surrounding the pet food bowl in a variety of configurations. For example, U.S. Pat. No. 5,577,461 discloses a moated food dish in which the food dish is removable from a moated base. However, these moated pet food bowls have problems. In some cases, the feeding apparatus involve a complex mechanism which may be prone to wear or breakage, such as U.S. Pat. No. 6,622,656 which discloses a pet-activated cover in addition to a moated base. The need for extra equipment to utilize a pet bowl may limit its placement, as in U.S. Pat. No. 5,564,363 which discloses a moated pet bowl which utilizes an inlet and outlet in order to keep liquid in the moat flowing, requiring location near a water source and a drain as well as the expense of constantly running water. In other cases, such as U.S. Pat. No. 5,485,806, the bowl is not removable from the moated area which may hinder refilling or cleaning of the bowl. Another problem with current moated bowls is that the moat needs to be of sufficient width or have multiple moats to adequately prevent insects and other pests from crossing. U.S. Pat. No. 5,253,609, teaches that ants and other insects are sometimes capable of crossing moats. If the pet is a smaller animal, such as a cat or a small dog breed such as a dachsund, the pet will have difficulty reaching over the moat system to eat or drink from the bowl.

Given the aforementioned problems with current pet food bowls using barriers or moats, it is therefore desirable to have a pet food bowl that can deter insects from reaching the food or liquid inside using a non-hazardous, easily obtainable substance such as water. It is also desirable for pet owners to have a pet food bowl uncomplicated in construction and easy to clean, which does not have limitations in placement. In addition, it is desirable to have a pest-deterring pet food bowl which is easily reached by smaller animals.

### SUMMARY OF THE INVENTION

The problems and limitations of current pet food bowls are overcome by the novel and unique features of the present invention. Described herein is an improved pet food bowl featuring multiple chambers configured and adapted to allow pets access to their food or drink, while preventing access by insects and other pests.

In one embodiment, the present invention contains a pet food bowl of two piece construction, wherein a detachable center chamber holds the food or drink, and a base chamber provides a barrier to unwanted pests. The base chamber has guides emerging from its bottom, which prevent or restrict movement of the detachable center chamber when it is placed in the base chamber. The center chamber is of such a diameter that when it is placed into the base chamber containing a non-toxic liquid, the width of the moat created between the outer wall of the base chamber and the edge of the center chamber is sufficient to prevent ants and other insects from crossing. The center chamber has a step emerging from its outer edge, allowing a small pet to cross the large moat and be able to reach the food in the center chamber. In addition, the center chamber is weighted so that it can remain in contact with the bottom of the base chamber even when the center chamber is empty.

### BRIEF DESCRIPTION OF THE DRAWINGS

FIGS. 1A, B, C—Side views of pest-deterrent bowl.

FIG. 2A—Side view of alternative pest-deterrent bowl shape.

FIG. 2B—Side view of multiple moats surrounding pest-deterrent bowl.

FIG. 3A—Perspective view of the anchoring edge of base chamber.

FIGS. 3B, C—Side view of friction grip of guides.

FIG. 4A—Perspective view of attachment mechanism of center chamber to base chamber.

FIG. 4B—Perspective view of alternative support member design.

FIGS. 5A, B, C—Side views of floating center chamber with guides.

FIG. 6—Perspective view of single-piece pest-deterrent bowl.

### DETAILED DESCRIPTION OF THE INVENTION

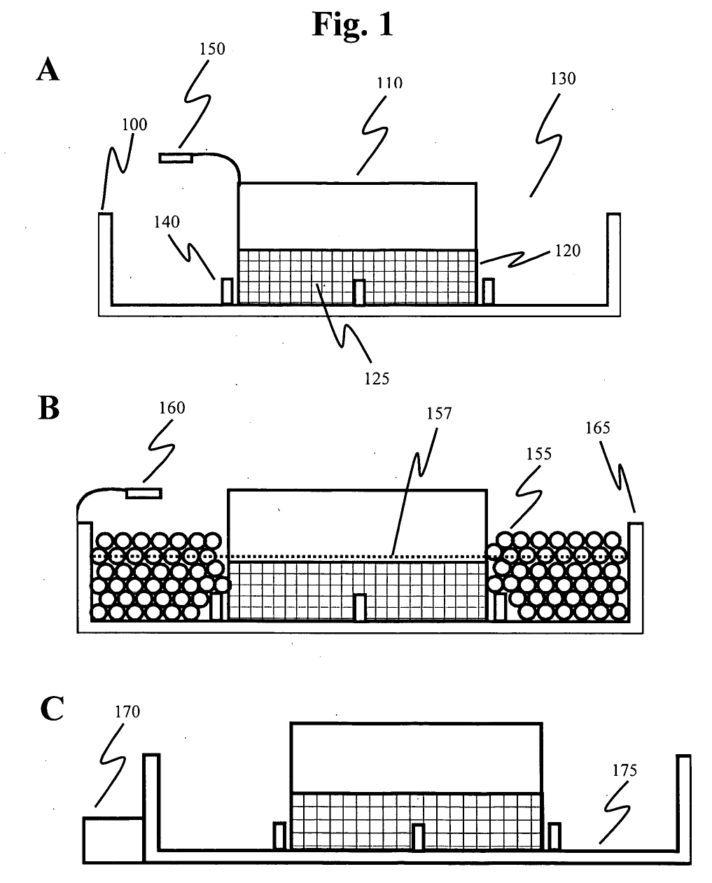

Referring to FIG. 1, this embodiment of the pest-deterrent food bowl comprises two pieces, a base chamber 100 capable of holding pest-deterrent liquid, such as water or vegetable oil, and a detachable center bowl 110 which is configured and adapted for holding solid pet food or liquid nourishment for a pet. In one preferred embodiment, the two pieces of the pest-deterrent food bowl are made from the same material. In other embodiments, the two pieces of the pest-deterrent food bowl can made from different materials. The pest-deterrent food bowl can be made of concrete, clay, ceramic, metallic, plastic, or other polymeric materials. The base chamber contains a weighting means to prevent a pet or human owner from accidentally tipping over the pest-deterrent food bowl. Such a weighting means may be, but is not limited to, metal, masonry, sand, or water. The weighting means can be integrated into the form of the base chamber itself or attached to the inside or outside of the base chamber. If the material used to construct the base chamber is sufficiently heavy, such as concrete or steel, the material itself can act as a weighting means.

Returning to FIG. 1, a support member 120 extends from the bottom of detachable center bowl 110. In a preferred embodiment, the support member is contiguous with the bottom of the detachable center bowl, and comprises a single-walled support of sufficient thickness to support the detachable center bowl above it and approximately follows the circumference of the bottom of the detachable center bowl. The support member wall may be concave when viewed from below, forming a small inverted cup beneath the center bowl, or the support member wall may be convex when viewed from below, forming a flared foot or rounded base beneath the center bowl.

In one embodiment, the support member is constructed comprising a plurality of holes 125. In this embodiment, these holes provide a means of escape for any air trapped inside the support member when the detachable center bowl is placed in a liquid-filled base chamber. The holes of this embodiment provide a considerable advantage because air trapped underneath the support member can force the entire center bowl to float free when the interior of the center bowl no longer contains food or liquid nourishment.

In an alternative embodiment, the support member is configured without holes or with holes place at a specified height such that a predetermined amount of air may be trapped beneath the center bowl. This would allow for controlled floating or buoyancy of the center bowl when placed in liquid. This buoyancy may be the same as the ballast weight of the bowl, slightly less than the ballast weight of the bowl, or about equal to the ballast weight of the bowl. The ballast weight of the bowl is meant to imply the net effective weight which tends to sink the bowl down into a fluid, such as water or any pest deterring liquid.

The support member 120 also contains a weighting means to prevent tipping of detachable center bowl, and to encourage positive engagement with the base and positive positioning of the center bowl. The weighting means can be contained within the form of the support member itself, or can be can comprise the material of the support member itself, or can contain some heavy material such as sand, water, or metal. When base chamber 100 is filled with pest-deterrent liquid and the detachable center bowl is placed inside the base chamber, a moat 130 is formed surrounding the detachable center bowl. The term “moat” is used throughout the description of this invention to indicate the space in between the center bowl and the edge of the base chamber, regardless of whether the space is filled with fluid or not. In some embodiments, the physical structure of the moat itself may provide a barrier function through features such as overhangs, blind edges, multiple small protrusions similar to a plastic comb or grooming brush, or labyrinth like passages which guide the insect away from the center bowl. In one preferred embodiment the combination of the moat and a pest-deterring substance creates the insect-repelling barrier. The pest-deterrent liquid may be provided with the unit, or supplied separately by the pet owner. For simplicity and safety, the pest deterrent liquid is preferably water or a water based solution. Alternatively, the pest deterrent liquid contains non-toxic oils such as baby oil or vegetable oil. Alternatively, the pest deterrent liquid may contain non-toxic or low-toxicity insecticidal soaps, and other additives such as salt or diatomaceous earth which have been known to deter pests. Alternatively, a pest-deterring substance such as a granular or powdered solid may be used in to improve ease of use or longevity of effectiveness. Solid or granular pest deterring substances may include barrier materials such as marbles or ball bearings, active materials such as a pest poison or insecticidal soap, or filler material such as a salt. Solid pest deterrent substances may be beneficially combined with other solids or liquids to provide further enhanced safety and efficacy. For example, as illustrated in FIG. 1B, a layer of round, oval, oblong or irregularly shaped rocks or marbles 155 may stand over a more effective but potentially more dangerous liquid 157 such as a pesticide, pest bait, or pest deterrent known in the chemical pest control or entomological arts to form a two-phase barrier, thus providing the effectiveness of an aggressive pesticide with the added safety of a physical barrier which prevents a large animal such as a household pet from contacting the liquid, while allowing smaller pests to reach the liquid. Preferably the width of the moat must be at least about three inches to prevent insects from crossing to the center chamber. In cases where space is at a premium and pests are less challenging, it may be desirable to configure the moat with a width of about two and one half inches. In cases where space is available and pests are more aggressive, it may be desirable to configure the moat with a width of about three and one half inches, alternatively four inches, alternatively six inches.

To maximize effectiveness at preventing insect intrusion while minimizing size, cost and usage of insect deterrent solids or liquids, the moat is preferably configured to hold liquid at about an inch deep, more preferably about one half inch deep, even more preferably about one quarter inch deep, most preferably about one eighth inch deep, and in some extreme cases may be only deep enough to maintain a cohesive film of liquid across the moat, one sixteenth of an inch deep, or less.

To provide a more stable or longer lasting insect-repelling barrier, the moat may be configured to hold liquid and/or solid material about two or three inches deep, or the moat may be about four or five inches in width. The moat may also be configured to allow steady or intermittent inflow and/or outflow of fluid with a fluid supply or reservoir and/or a fluid drain or return.

Returning to FIG. 1A, multiple guides 140 extend vertically from and are contiguous with the bottom of base chamber 100 and are spaced around the circumference of the detachable center bowl in such a manner that the detachable center bowl is unable to slide laterally within the base chamber. In one embodiment, the guides are separate protrusions emerging from the base chamber floor. In another embodiment, a single contiguous guide extends vertically from the bottom of the base chamber such that the guide surrounds the circumference of the support member of detachable center bowl.

In one preferred embodiment, a single step 150 extends from and is contiguous with the outer edge of the detachable center bowl 110, as shown in FIG. 1A. The step 150 extends partially across moat 130, allowing a pet or other small animal to easily move its head across the moat in order to reach the food or liquid nourishment contained in the center bowl. Such a step can also be configured, dimensioned and adapted for use as a handle for removing and replacing the center bowl. In another embodiment, multiple steps are spaced at regular intervals around the outside of the detachable center bowl. In yet another alternative embodiment, the step is a contiguous support emerging from and surrounding the circumference of the center bowl. In still another alternative embodiment, illustrated in FIG. 1B, the step 160 is located on the outer edge of the base chamber 165 and extends partially across the moat. In another embodiment, illustrated in FIG. 1C, the step 170 emerges from the outer wall of the base chamber 175 to protrude past the circumference of the base chamber, allowing greater stability of the invention. In yet another alternative embodiment, the step comprises an indentation into a portion of the outside wall of the base chamber which would minimize protrusions and allow for placement of the bowl in confined spaces.

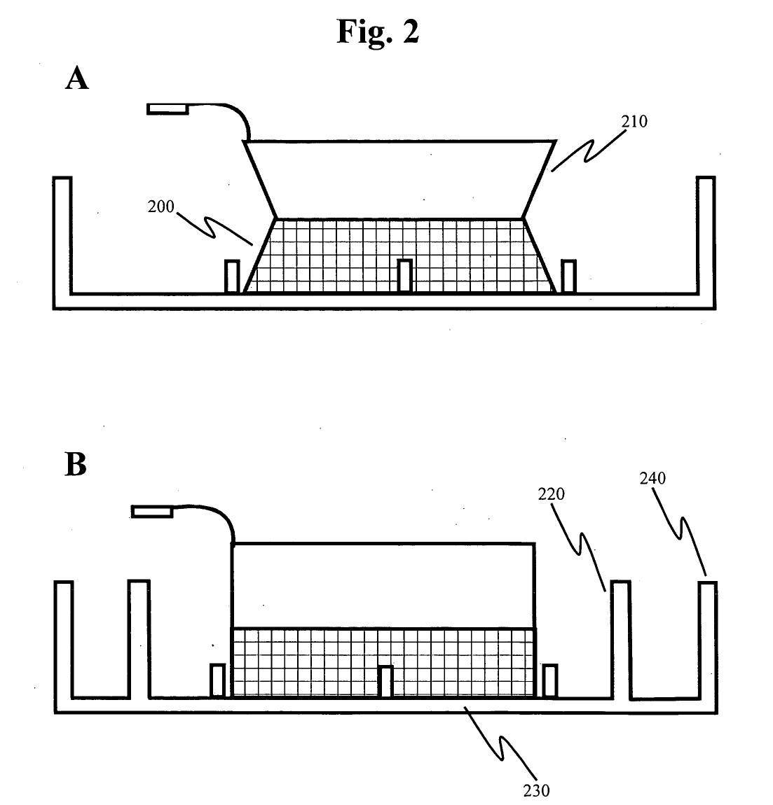

While the shapes of the base chamber, detachable center bowl, and the support member illustrated in FIG. 1 are all basic cylinders, these three parts are not limited to a cylindrical geometry. The shapes of each of these parts can have other shapes, including, but not limited to, ovals, ellipsoids, rectangles, triangles, and other types of polygons, rectilinear or curvilinear constructs. The shapes of each part may also be different within a given pest-deterrent food bowl, for example, a square support member extending from a round parabolic bowl. One preferred embodiment of the pest-deterrent food bowl matches the shapes of the detachable center bowl and the base chamber such that a moat of uniform diameter surrounds the detachable center chamber. FIG. 2A illustrates another embodiment of the pest-deterrent bowl in which the support member 200 of center bowl is frusto-conical in shape and the chamber portion 210 of the center chamber is an inverted frusto-conical shape. In an alternative embodiment, the bowl is flattened on one side so that the bowl can be placed close to a wall or obstruction in the ground. Other shapes and geometries are also contemplated by this invention.

FIG. 2B illustrates yet another embodiment of the pest-deterrent food bowl in which an additional dividing wall 220 rises from the bottom of the base chamber 230, forming a second moat 240. Additional dividing walls may be contemplated by the present invention to form additional moats.

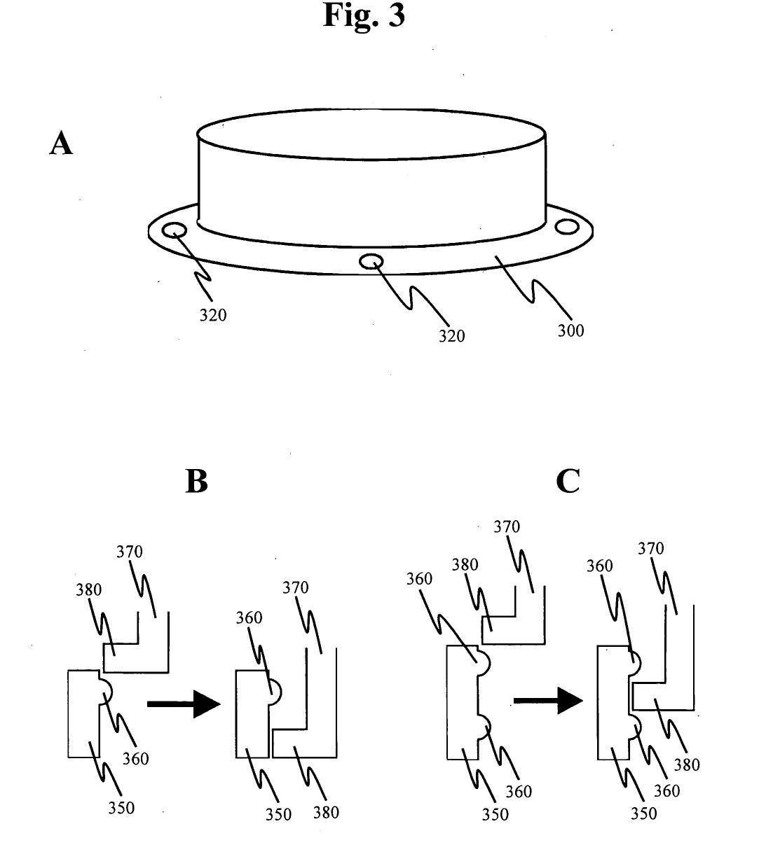

In another embodiment of the base chamber, illustrated in FIG. 3A, the base chamber has an anchoring rim 300, comprising a horizontal lip extending from the bottom outer edge of the base chamber along with at least two anchoring holes 320 penetrating the anchoring rim. These anchoring holes allow the user to place screws, spikes or other anchoring means through them in order to keep the entire pest-deterrent bowl from sliding along the ground.

Other embodiments of the pest-deterrent food bowl provide for the center bowl to fixedly attach to the guides in the base chamber, yet still allow removal of the center bowl if desired. FIG. 3B illustrates part of another embodiment of the pest-deterrent food bowl in which the guides and the bottom edge of the support member portion of the center bowl are constructed so that the center bowl is fixed in place, yet detachable with the application of modest force. In this embodiment of the pest-deterrent food bowl, the base chamber and guides comprise a stiff yet pliable material such as polypropylene, ABS or other engineering plastics. In FIG. 3B, a guide 350 has a protuberance 360 facing the center of the base chamber, while the outer edge of the support member 370 has a small lip 380. The size of the guides' protuberance is such that when the center bowl is placed in the base chamber, the protuberance exerts resistance against the small lip of the support member. When sufficient force is exerted downward on the center bowl, the small lip is forced past the protuberance and the bottom of the support member is able to rest on the bottom of the base chamber, thus allowing the bowl to snap in place with a prescribed force. It is known in the plastics manufacturing and design arts how to configure and dimension such snap features such that a prescribed insertion and pullout force is required to place and remove the center bowl. The insertion force can be about the same as, greater than or less than the pullout force. In an alternative embodiment each guide has multiple protuberances at different heights along the guide, such that the center bowl can be placed into the base chamber at multiple heights. In a further embodiment illustrated in FIG. 3C one or more protuberances 360 may be configured and adapted such that the bowl is selectively designed to float or move a controlled difference up or down, either before or after snapping into a new position. For example, the bowl could be configured to slide down to a first stop, snap past that point with application of a predetermined force (applicable by an average adult hand), then slide freely up and down between the guides for a distance of one inch, before snapping firmly into place at a lower setting with application of a predetermined force (applicable by the desired pet, e.g., a cat) where the lower setting may be designed to either hold the bowl at a fixed height, or allow a second range of motion before clicking into a third, even lower setting. In all cases, the pullout force required to remove the bowl from a given snap fit level may be designed to control motion of the bowl, e.g., the lowest snap may be designed, dimensioned and configured to allow the bowl to pop back up under a predetermined force of buoyancy caused by the bowl in the liquid of the moat after the pet steps away, while the highest snap may be designed, dimensioned and configured to require the greater force applied by a human hand to fully remove the bowl. In this way protection of the food, access of the pet and ease of use are all concurrently maximized.

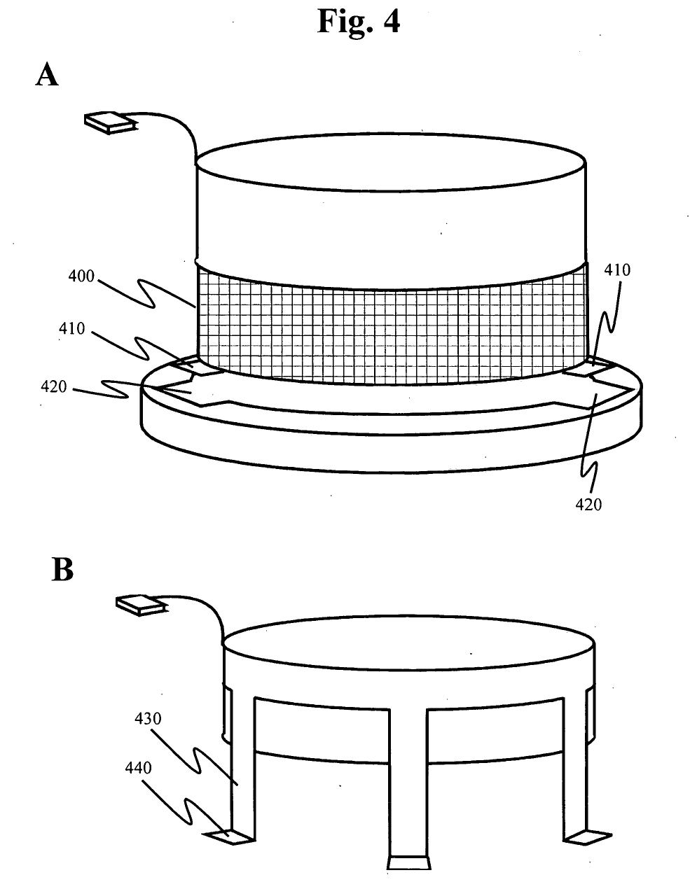

In another embodiment of the invention, illustrated in FIG. 4A, the bottom edge of the support member 400 has laterally protruding tabs 410 which interact with notches in the guides 420 and together act as a tongue-and-groove construction. Another embodiment of the center bowl is illustrated in FIG. 4B. The support member of the center bowl comprises at least three separate legs 430, each leg having laterally protruding tabs 440. Another embodiment of the invention provides for grooves on the interior of the guides in the base chamber, allowing a center bowl with tabs or a rim on the bottom outer edge to screw into the grooved guides, much as a bottle cap would screw onto a liquid container. This embodiment has the advantage of allowing the user to easily adjust the height of the center chamber depending on how far the user screws it down, and the further advantage of ease of use is gained by a commonly known interface paradigm allowing rapid and intuitive placement and removal. In yet another embodiment, the support member and the bottom of the base chamber comprise one or more magnets configured in opposite polarities, such that the support member and the base chamber are magnetically attracted to one another in order to correctly align the center bowl in the middle of the base chamber. Alternatively, the support member and the bottom of the base chamber may comprise one or more magnets of the same polarity, such that the magnets are repelled from one another in order to correctly align the center bowl in the middle of the base chamber. Alternatively, the center bowl and base chamber may each comprise two or more magnets of opposite polarities, such that the user can easily align the center bowl in the base chamber. Regardless of the magnet polarities used, enough magnets can be positioned on both the center bowl and the base chamber such that the center bowl is self-centering.

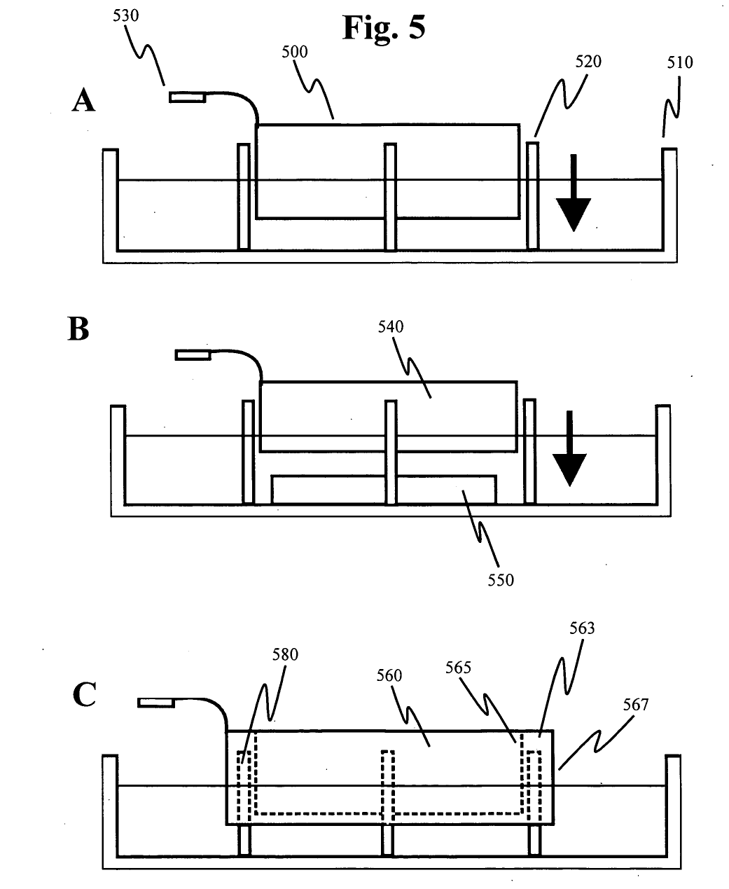

In yet another embodiment of the invention, the center bowl floats in the liquid of the base chamber. FIG. 5A is an illustration of this embodiment comprising the floating center bowl. Center bowl 500 floats in the liquid of the base chamber 510 and is of sufficient buoyancy to ensure that the center bowl's top rim is situated well above the plane of the liquid level in order to prevent accidental submersion. The center bowl may be formed from injection molded plastic. The plastic itself could be less dense than the liquid in the base chamber allowing it to float. The buoyancy of the center bowl may also be achieved using non-communicating air chambers built into the bowl itself, or any buoyant material attached to the center bowl, such as foam, balsa wood, or a low density polymer. The center bowl may also have a small weight attached to the bottom as a stabilizer to help prevent the center bowl from capsizing while being filled or used by a pet.

Returning to FIG. 5A, the center bowl 500 is surrounded by a number of guides 520 emerging from and contiguous with the base chamber 510 which maintain the center bowl's position in the middle of the base chamber. When a pet steps onto the step 530 emerging from the edge of the center bowl 500, the center bowl sinks down until the center bowl rests on the bottom of the base chamber 510. In another embodiment, illustrated in FIG. 5B, the center bowl 540 sinks down to rest on a submerged platform 550. In one such embodiment, the platform is a solid piece attached to the base chamber. In another such embodiment, the platform comprises a multitude of closely spaced bristles which emerge from the bottom of the base chamber. In another embodiment, illustrated in FIG. 5C, the center bowl 560 comprises a gap 563 between the wall of the inner bowl 565 and an outer facade wall 567 into which the guides 580 fit.

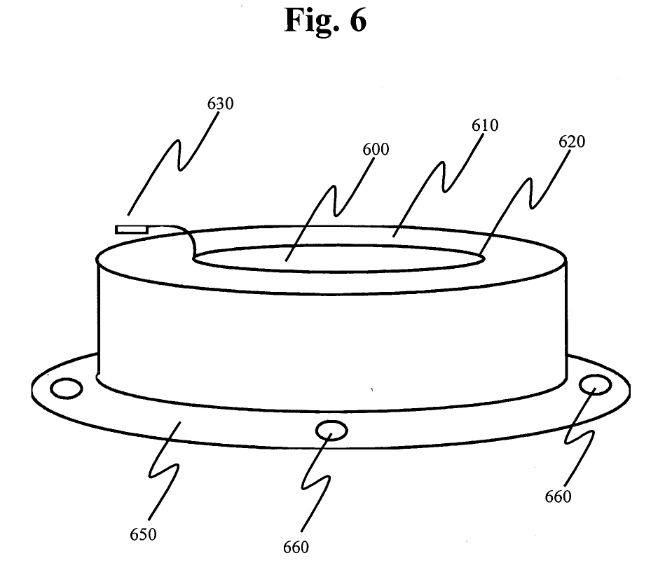

In still another embodiment of the pest-deterrent food bowl, the entire unit comprises a single piece rather than two pieces, as illustrated in FIG. 6. In this embodiment, a non-detachable center chamber 600 is separated from an outer chamber 610 by a dividing wall 620. A single step 630 extends from and is contiguous with the dividing wall 620. The step 630 extends partially across outer chamber 610, allowing a pet or other small animal to easily move its head across the chamber in order to reach the food or liquid nourishment contained in the center chamber. In another embodiment of this single piece bowl, the food bowl has an anchoring rim 650, comprising a horizontal lip extending from the bottom outer edge of the base chamber along with at least two anchoring holes 660 penetrating the anchoring rim. These anchoring holes allow the user to place screws, spikes or other anchoring means through them in order to keep the entire pest-deterrent bowl from sliding along the ground. In another embodiment, multiple steps are spaced at regular intervals around the outside of the detachable center bowl. In yet another embodiment of the single piece bowl, the outer chamber comprises multiple dividing walls, creating multiple outer chambers.

In another embodiment, the center bowl itself provides additional barriers to prevent intrusion of pests. Preferably, these barriers include one or more additional moats, at about the level of the edge of the food containing bowl, or about at the level of the moat provided in the base chamber. The barriers could also include overhangs, undercut walls, glue or resin similar to fly paper, surfaces which are alternatively exposed and submerged as the center bowl moves up and down within the pest deterrent liquid, or small protrusions which would be difficult for pests to navigate, or which may serve to hold or retain the pest-deterrent liquid.

The pest deterrent food bowl may be configured so that at least one moat is below the level of the food storage area. Alternatively, the pest deterrent food bowl may be configured so that at least one moat is at a height about equal to that of the food storage area. Alternatively, the pest deterrent food bowl may be configured so that at least one moat is above the level of the food storage area. Alternatively, the pest deterrent food bowl may be configured so that there are multiple moats, of the same or different heights, some or all of which are below, equal to, or above the food storage area.

Moats above the food storage area are desirable because they may provide superior pest protection. Moats which are below the food storage area are desirable because they provide ease of access and vision for the pet when reaching the food. Moats equal in height to the food storage area provide an aesthetically pleasing compromise between protection and ease of access. Combinations of one or more moats of varying or the same height may provide elements of all of these advantages.

One or more steps reaching our across a portion of a moat are desirable because they may allow the pet to obtain access across a wider moat, which may in turn provide better pest protection. Preferably, steps are attached to the center bowl. Alternatively, steps are attached to the outer chamber. Preferably the step is a simple, inexpensive and reliable molded plastic piece, which moves the center bowl or flexes when stepped on by an appropriately sized pet. Also preferably, the step will reach a stop by pressing against a surface of the outer chamber following a predetermined amount of motion. Alternatively, the protrusions on the center bowl may interact with the outer chamber to stop motion of the center bowl at a predetermined point. The motion and/or flex of the step can be tuned to allow access by a small pet such as a cat, but deny access to a larger pet such as a dog by tipping too far, bending out of the way, or dipping the larger (and heavier) pet's foot into the liquid. The step may also be configured to prevent access by smaller pets or pests such as squirrels by not moving without sufficient force, or by only reaching part way across the moat (and thus requiring the pet to be of sufficient size to reach the rest of the way).

Alternatively, the step may be connected to a simple linkage, so that a predetermined pressure or force applied to the step causes an action such as stabilization of the center bowl, uncovering of a moveable cover or lid from the food storage area, or tipping of the bowl toward or away from the step. The action and type of linkage motion can be configured to support various desirable outcomes such as protecting the food from the elements, minimizing odor escaping from the food, or stirring or manipulating one or more moats to improve pest protection. In one preferred embodiment, the linkage is a simple lever with a single pivot, such the downward motion of the step causes upward motion of the center bowl, raising it to the level of the pet's mouth for easier access, especially for an older pet or one with difficulty bending down to reach the food.

I claim:

1. A pest-deterrent pet food bowl of two piece construction, comprising:
a) a detachable center bowl configured and adapted for holding liquid or solid foods for pet consumption;
b) a support member emerging from the bottom of said detachable center bowl, configured and dimensioned to prevent center bowl from tipping, said support member containing a ballast mass of sufficient weight to prevent it from floating in a pest deterring liquid;
c) a base chamber configured and adapted for holding pest-deterring liquid, said base chamber configured with guides to align said support member in the center of base chamber, such that when said detachable center bowl is placed in said base chamber, a moat of at least 3 inches is created which surrounds said detachable center bowl; and
d) at least one step emerging from an edge of said detachable center bowl and rising over and at least partially across said moat, configured and dimensioned to allow a pet to stand on said step and reach said detachable center bowl for consumption of liquid or solid food.

2. The pest-deterrent bowl of claim 1, wherein said moat holds both a pest-deterrent liquid and a solid granular substance which covers said pest-deterrent liquid.

3. The pest-deterrent bowl of claim 1, wherein the bottom of said base chamber comprises an outer anchoring rim extending beyond said base chamber, said outer anchoring rim having at least one hole configured to accept an anchoring screw to affix said pest-deterrent bowl to the ground.

4. The pest-deterrent bowl of claim 3, wherein said support member comprises a single-walled piece extending from the bottom of said detachable center bowl and having a plurality of holes, such that air inside said support member is released when submerged in a liquid.

5. The pest-deterrent bowl of claim 4, wherein the bottom of said support member comprises lateral protrusions configured and adapted to interact with said guides so as to reversibly hold said detachable center bowl in place.

6. The pest-deterrent bowl of claim 4, wherein said support member is circular in shape and said lateral protrusions lock into said base chamber via a tongue-and-groove connection.

7. The pest-deterrent bowl of claim 4, wherein said support member contains at least one magnet of a given polarity, which attracts or repels at least one other magnet integrally attached to said base chamber.

8. The pest-deterrent bowl of claim 4, wherein said pest-deterrent bowl comprises an additional chamber of at least 3 inches wide, such that when said detachable center bowl is placed inside said base chamber, two concentric moats are created.

9. The pest-deterrent bowl of claim 3, wherein said support member comprises at least 3 legs extending from the bottom of said detachable center bowl.

10. The pest-deterrent bowl of claim 9, wherein each of said legs comprises at least one lateral protrusion configured and adapted to interact with said guides to reversibly hold said detachable center bowl in place.

11. The pest-deterrent bowl of claim 9, wherein each of said legs comprises a foot with a lateral protrusion that allows center bowl to lock into base chamber via a tongue-and-groove connection.

12. The pest-deterrent bowl of claim 9, wherein said support member contains at least one magnet of a given polarity, which attracts or repels at least one other magnet integrally attached to said base chamber.

13. The pest-deterrent bowl of claim 9, wherein said pest-deterrent bowl comprises an additional chamber of at least 3 inches wide, such that when said detachable center bowl is placed inside said base chamber, two concentric moats are created.

14. A pest-deterrent pet food bowl of two piece construction, comprising:
a) a detachable center bowl configured and adapted for holding liquid or solid foods for pet consumption, said center bowl being configured and adapted to float in a pest deterring liquid;
b) a base chamber configured and adapted for holding pest-deterring liquid, said base chamber comprising guides configured and dimensioned to align said detachable center bowl in the center of base chamber, such that when pest deterring liquid is added and detachable center bowl is allowed to float in said base chamber, a moat of at least 3 inches in width is created which surrounds said detachable center bowl; and
c) at least one step emerging from said detachable center bowl and reaching over and at least partially across said moat, allowing pet to stand on said step to reach detachable center bowl for consumption of liquid or solid food.

15. The pest-deterrent bowl of claim 14, wherein said base chamber comprises an outer anchoring rim extending past the circumference of said base chamber, said outer anchoring rim having at least one hole sized to accept an anchoring screw to affix said pest-deterrent bowl to the ground.

16. The pest-deterrent bowl of claim 15, wherein said support member contains at least one magnet of a given polarity, which attracts or repels at least one other magnet integrally attached to said base chamber.

17. The pest-deterrent bowl of claim 15, wherein said pest-deterrent bowl comprises an additional chamber at least 3 inches wide, such that when said detachable center bowl is placed inside said base chamber, two concentric moats surround said detachable center bowl.

18. A pest-deterrent pet food bowl of single piece construction, comprising:
a) a center bowl configured and adapted for holding liquid or solid foods for pet consumption;
b) an outer chamber wall surrounding said center bowl at a distance of at least 3 inches in width, said outer chamber wall configured and adapted to form a moat capable of holding a pest deterring liquid in the space between said outer chamber wall and said center bowl;
c) at least one step extending over and partially across said moat, said step configured and adapted to allow a pet to stand on said step and reach detachable center bowl for consumption of liquid or solid food.

19. The pest-deterrent bowl of claim 18, wherein the bottom of said base chamber comprises an outer anchoring rim extending past the circumference of said base chamber, said outer anchoring rim having at least 2 holes sized to accept an anchoring screw to affix said pest-deterrent bowl to the ground.

20. The pest-deterrent bowl of claim 18, wherein said pest-deterrent bowl comprises an additional chamber of at least 3 inches wide surrounding said base chamber, such that two concentric moats are created when a pest deterring liquid is added between said outer chamber wall and within said additional chamber.
